(19) United States
(12) Patent Application Publication
(10) Pub. No.: US 2002/0109589 A1
(43) Pub. Date: Aug. 15, 2002

(54) Apparatus for preventing automobiles from being stolen

(76) Inventor: Gye-Hwan Kang, Incheon (KR)

Correspondence Address: Warner Norcross & Judd LLP, 900 Old Kent Building, 111 Lyon Street, N.W., Grand Rapids, MI, 49503-2487, US

(21) Appl. No.: 10/071,714

(22) Filed: Feb. 7, 2002

(30) Foreign Application Priority Data
Feb. 9, 2001 (KR) 2001-6339

(51) Int. Cl. B60R 25/10

(52) U.S. Cl. 340/426; 340/539

(57) ABSTRACT

An apparatus for preventing an automobile from being stolen is disclosed, in which an actuation part consisting of an electromagnet and an actuation plate is connected to a wire connecting an accelerator pedal and a carburetor throttle vale, and further, a control part is made to control the supply of a power to the electromagnet. Thus if a remote controller is used to set the automobile to a stealth preventing mode, then the power is not supplied to the electromagnet, and therefore, the accelerator pedal is disconnected from the carburetor throttle valve, with the result that the automobile cannot run.

### FIELD OF THE INVENTION

The present invention relates to an apparatus for preventing an automobile from being stolen. More specifically, the present invention relates to an apparatus for preventing an automobile from being stolen, in which an actuation part consisting of an electromagnet and an actuation plate is connected to a wire connecting an accelerator pedal and a carburetor throttle vale, and further, a control part is made to control the supply of a power to the electromagnet. Thus if a remote controller is used to set the automobile to a stealth preventing mode, then the power is not supplied to the electromagnet, and therefore, the accelerator pedal is disconnected from the carburetor throttle valve, with the result that the automobile cannot run.

### BACKGROUND OF THE INVENTION

There has been a conventional automobile stealth preventing apparatus in which a disconnection is done between the accelerator, the carburetor and the engine. This is Korean Patent Application No. 2000-32598 which was filed by the present inventor.

In this prior art, however, the constitution is too much complicated, and too many components are required, while too much time is required in manufacturing and assembling the components. Further, disorders are frequent, and the bulk is too large, while the installation of it is complicated and troublesome.

### SUMMARY OF THE INVENTION

The present invention is intended to overcome the above described disadvantages of the conventional technique.

Therefore it is an object of the present invention to provide an apparatus for preventing an automobile from being stolen, in which the constitution is simple, the installation is easy, and economy is ensured.

In achieving the above object, the apparatus for preventing an automobile from being stolen according to the present invention includes: a control part for receiving radio wave signals;

an actuation part consisting of: an electromagnet electrically connected to the control part, for being electrically turned on or turned off in accordance with a mode setting by the control part; a metallic actuation plate for being attached to the electromagnet owing to a magnetic force upon supplying a power to the electromagnet; an elastic spring for pushing the electromagnet so as to make the electromagnet contacted to the actuation plate at all times at a normal running mode; and a housing for accommodating the electromagnet, the actuation plate and the spring; and

a wire consisting of two pieces connected respectively to the electromagnet and the actuation plate, other ends of them being respectively connected to an accelerator pedal and a carburetor throttle valve.

### BRIEF DESCRIPTION OF THE DRAWINGS

The above object and other advantages of the present invention will become more apparent by describing in detail the preferred embodiment of the present invention with reference to the attached drawings in which:

FIG. 1 illustrates the constitution of the apparatus according to the present invention, showing its total connection;

FIG. 2 is a sectional view showing the internal constitution of the actuation part as the critical portion of the present invention;

FIG. 3 is a cutout view showing the actuation of the actuation part during the normal running of the automobile; and

FIG. 4 is a cutout view showing the actuation of the actuation part at a stealth-preventing mode.

### DETAILED DESCRIPTION OF THE PRFERRED EMBODIMENT

The preferred embodiment of the present invention will be described in detail referring to the attached drawings.

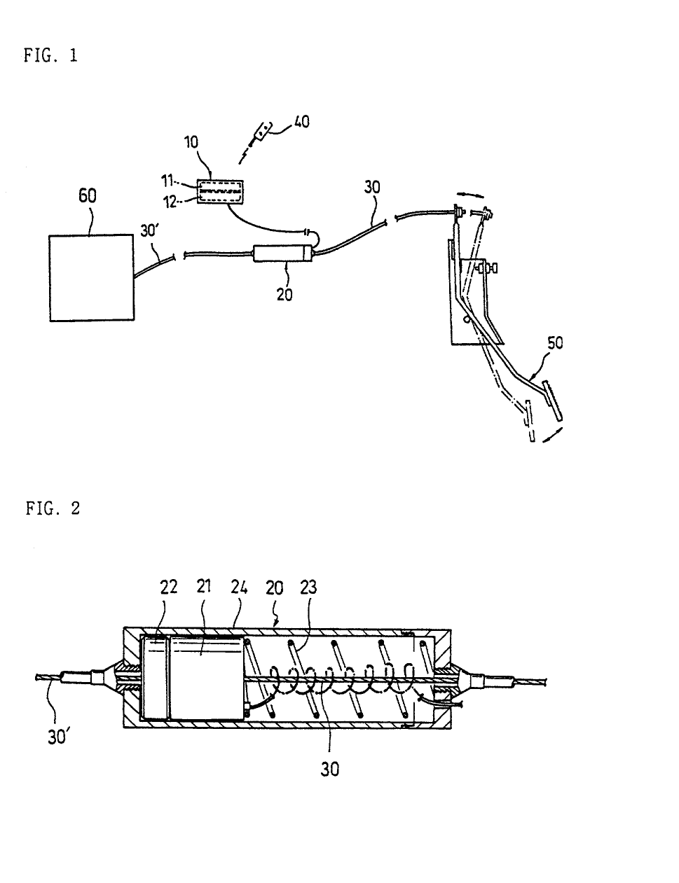

Referring to FIG. 1, the apparatus for preventing an automobile from being stolen according to the present invention includes: a control part 10 installed within the automobile, for receiving radio wave signals from a remote controller 40; and an actuation part 20 for connecting or disconnecting an accelerator pedal part 50 to an from a carburetor 60 in accordance with controls by the control part 10.

The actuation part 20 includes: an electromagnet 21 electrically connected to the control part 10, for being electrically turned on or turned off in accordance with a mode setting by the control part 10; a metallic actuation plate 22 for being attached to the electromagnet 21 owing to a magnetic force upon supplying a power to the electromagnet 21; an elastic spring 23 for pushing the electromagnet 21 so as to make the electromagnet 21 contacted to the actuation plate 22 at all times at a normal running mode; and a housing 24 for accommodating the electromagnet 21, the actuation plate 22 and the spring 23.

The control part 10 is electrically connected to the electromagnet 21 of the actuation part 20, and receives signals from a remote controller 40 to supply or withhold a power to or from the electromagnet 21.

The control part 10 consists of a first control part 11 and a second control part 12, and the second control part 12 is a reserved one to be used in case of a disorder of the first control part 11.

The housing 24 is made of a non-magnetic metal or a synthetic resin, so that it would not be influenced by the magnetic flux of the electromagnet 21.

The actuation plate 22 is made of a magnetic material, so that it would be attracted to a magnetic source. The electromagnet 21 and the actuation plate 22 are slidably installed within the housing 24, and the electromagnet 21 is contacted to the actuation plate 22 by the elastic force of the spring 23 as shown in FIG. 2.

A wire 30′ is connected between the actuation plate 22 and the throttle valve of a carburetor 60, while a wire 30 is connected between the electromagnet 21 and the accelerator pedal part 50. The electromagnet 21 is electrically connected through an electric wire to the control part 10.

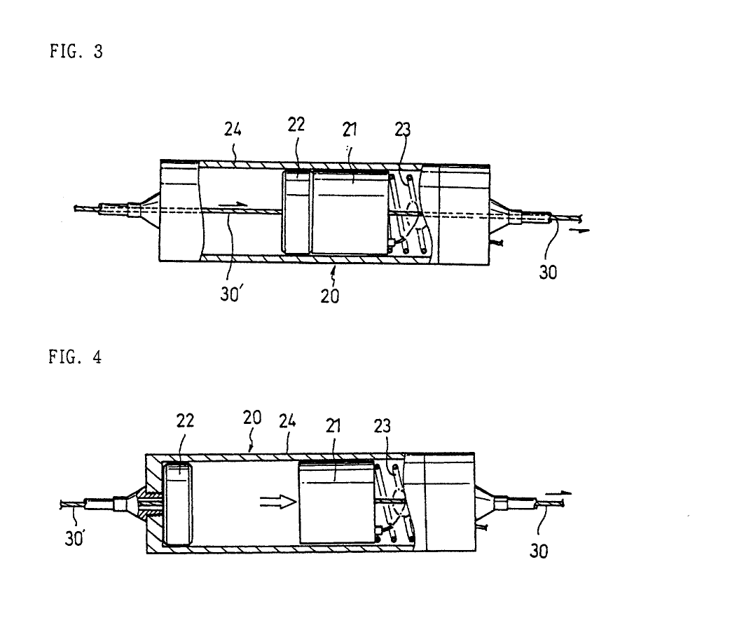

In this apparatus constituted as described above, if the user sends signals through the remote controller 40 to the control part 10 to supply a power to the electromagnet 21, then the actuation plate 22 is strongly attached to the electromagnet 21 owing to the magnetic force of the electromagnet 21. Thus if the accelerator pedal part 50 is pressed as shown by the one-dot chain line in FIG. 1, all the components such as the wire 30, the electromagnet 21, the actuation plate 22 and the wire 30′ are pulled together as shown in FIG. 3, thereby making the automobile run.

Meanwhile, after the running, if the user sends signals through the remote controller to the control part 10 to make the power disconnected, that is, if a stealth preventing mode is set, then the following phenomenon occurs. That is, even if a thief intrudes into the car, and even if the thief presses the accelerator pedal part 50, then only the electromagnet 21 is pulled, but the actuation plate 22 and the wire 30′ are not pulled. Therefore, the automobile cannot be made run, thereby preventing the automobile from being stolen.

According to the present invention as described above, the constitution of the apparatus is simple, its installation is easy, and the manufacture and assembling of the components are easy. Thus economy is ensured, disorders are infrequent.

What is claimed is:

1. An apparatus for preventing an automobile from being stolen, comprising:
a control part 10 for receiving radio wave signals from a remote controller 40;
an actuation part 20 for realizing a connection or disconnection between an accelerator pedal part 50 and a carburetor 60, and comprising: an electromagnet 21 electrically connected to the control part 10, for being electrically turned on or turned off in accordance with a mode setting by the control part 10; and a metallic actuation plate 22 for being attached to the electromagnet 21 owing to a magnetic force upon supplying a power to the electromagnet 21, and housed within a housing 24; and
the actuation plate 22 being connected through a wire 30′ to a throttle valve of the carburetor 60, and the electromagnet 21 being connected through a wire 30 to the accelerator pedal part 50.

2. The apparatus as claimed in claim 1, wherein the control part consists of a first control part 11 and a second control part 12.

3. The apparatus as claimed in claim 1, further comprising: an elastic spring 23 for pushing the electromagnet 21 so as to make the electromagnet 21 contacted to the actuation plate 22 at all times at a normal running mode.
